(19) United States
(12) Patent Application Publication
(10) Pub. No.: US 2026/0244816 A1
(43) Pub. Date: Aug. 20, 2026

(54) SIMULATING DYNAMIC SOLAR HARVESTING WITH MODELLING OF DIFFUSE SHADOWS

(71) Applicant: CARNEGIE MELLON UNIVERSITY, Pittsburgh, PA (US)

(72) Inventors: PHILIP LEDUC, Pittsburgh, PA (US); ANDRES ARIAS-ROSALES, Pittsburgh, PA (US)

(73) Assignee: CARNEGIE MELLON UNIVERSITY, Pittsburgh, PA (US)

(21) Appl. No.: 18/872,168

(22) PCT Filed: Aug. 29, 2023
(86) PCT No.: PCT/US2023/031325

§ 371 Date: Dec. 5, 2024

Related U.S. Application Data
(60) Provisional application No. 63/402,240, filed on Aug. 30, 2022.
(60) Provisional application No. 63/402,277, filed on Aug. 30, 2022.
(60) Provisional application No. 63/527,909, filed on Jul. 20, 2023.

(51) Int. Cl. G06F 30/20

(52) U.S. Cl. CPC G06F 30/20

(57) ABSTRACT

Disclosed herein is a novel method for modelling and simulating urban solar harvesting by modeling the components of solar radiation using a modelling framework with modules related to view factors, transmittance, beam and diffuse shadow modeling, heat transfer equilibrium, and a virtual environment that emulates urban infrastructure and receives weather and radiation data as inputs. Also disclosed herein are various approaches for modelling diffuse shadows, which are a component of the integrated modelling framework. The various modules are integrated and optimized to compose several versions of modeling and simulation tools, which can estimate the temperature, power, and energy output of dense groups of freely-defined dynamic solar harvesting surfaces in urban and other intricate scenarios characterized by high three-dimensionality.

### RELATED APPLICATIONS

This application is a non-provisional of, and claims the benefit of U.S. Provisional Patent Applications Nos. 63/402,240, filed Aug. 30, 2022, entitled “Method for Modelling Anisotropic Diffuse Shadows Using Geometrical Mapping, Rasterization and Pixel-Counting”, 63/402,277, filed Aug. 30, 2022, entitled “Simulating 3D Dynamic Solar Harvesting Swarms in Urban Environments” and 63/527,909, filed Jul. 20, 2023, entitled “Solar Harvesting Swarms in Dynamic and 3D Urban Environments: Modeling and Simulation”, the contents of which are incorporated herein in their entireties.

### GOVERNMENT INTEREST

This invention was made with United States Government support under contract AG061005 awarded by the National Institutes of Health and contract 1946456 awarded by the National Science Foundation. The U.S. Government has certain rights in the invention.

### BACKGROUND

With the world's population increasingly concentrated in urban areas, modern cities are arguably the epicenter of human development and technological innovation. Cities are also where meeting the intense energy demand sustainably and efficiently is one of the most critical challenges. Although urban areas represent only 3% of the land mass of surface of the Earth, they concentrate 50-55% of the population, 60-80% of the global energy consumption, and 70% of the total human-induced greenhouse emissions. As the proportion of urbanized population grows, transitioning to more sustainable models of urban production and consumption is becoming increasingly more decisive. Thanks to steadily improving cost-effectiveness, safety, modularity and versatility, intelligent solar harvesting infrastructure will be key in a paradigm shift in which cities work to become producers of energy resources rather than just recipients. Solar energy-related markets are emerging and new exciting technologies are being developed in building-integrated Photovoltaics (PV), solar harvesting windows, solar tiles, vehicle-integrated PV, solar roads, PV scooter chargers, solar-powered drones for package delivery, transportation, maintenance, or security, and hybrid systems combining residential PV with small wind turbines or urban farming.

With the proper modeling and simulation tools, every exposed surface in a future urban infrastructure may have the potential to harvest solar energy to improve efficiency, resilience, and energy democratization, as well as have secondary functionalities like thermal insulation, weatherproofing, structural support, shading elements for human comfort, and may even contribute to architectural aesthetics.

The ability to create computational models and, eventually, digital twins of infrastructure will allow millions of iterations for optimization versus running orders of magnitude fewer experimental scenarios that are far more expensive and time consuming.

Urban solar harvesting is limited by many constraints and radiation interactions that are challenging to capture, such as diffuse transmittance losses and shading caused by fixed and moving infrastructure. Many common simplifications that are reasonable in open spaces may lead to insufficient geometrical flexibility or non-negligible inaccuracies in more complex 3D urban environments. Thus, developing modeling frameworks and computational capabilities that balance accuracy with efficiency, practicality, and geometrical flexibility is critical for the design, optimization, control, and forecasting of urban solar devices. Creating models and eventually digital twins of 3D environments for solar harvesting will allow millions of iterations for finding optimal approaches versus the constraints of solely experimental implementation, which would be orders of magnitude fewer iterations as well as being more expensive and time consuming.

Further, available solar resources are limited by geometric constraints and shading caused by urban infrastructure as the spatio-temporal distribution of solar irradiation is significantly influenced by urban morphology. Shadow-casting objects include, for example, nearby buildings and their features (i.e., chimneys, facade prominences, shadows from other harvesting devices, etc.) and the surrounding terrain and distant objects at the horizon. Shadows may hinder the general intensity of solar irradiance and, if they cause abrupt changes in illumination (i.e., hard partial shadows), then dangerous electrical mismatches and hotspots can occur. Therefore, modeling shadows accurately is critical to estimating power output and maximizing solar harvesting, especially in intricate urban environments characterized by limited area and complex irradiance interactions with fixed and moving shadow-casting objects.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In a first aspect of the invention, disclosed herein is a novel system and method for simulating urban solar harvesting through modeling the components of solar radiation in terms of view factors, transmittance, and shadow casting, while balancing accuracy, efficiency, practicality, and geometrical flexibility. The system and method can be used to analyze the solar harvesting potential of emerging urban applications through simulations in 3D virtual environments that mimic real-life urban infrastructure long with bio-inspired optimization and control strategies.

The method comprises a modelling framework with modules related to irradiance decomposition, view factors, transmittance, beam and diffuse shadow modeling, heat transfer equilibrium, photovoltaic efficiency, and a virtual environment that emulates urban infrastructure and receives weather and radiation data as inputs.

In a second aspect of the invention, disclosed herein are several novel methods for modelling diffuse shadows, which are a component of the modelling framework of the first aspect. The objective of diffuse shadow modeling is estimating how much of the diffuse irradiance reaches a harvesting surface by finding the diffuse unshaded factors (USF), which is the proportion of irradiance that is available to a harvesting surface in an actual virtual scene compared to a reference virtual scenario for which no shadows are accounted.

### BRIEF DESCRIPTION OF THE DRAWINGS

By way of example, specific exemplary embodiments of the disclosed systems and methods will now be described, with reference to the accompanying drawings, in which:

FIG. 1 shows the anisotropic components of solar irradiance and the basic concept of how angular sampling is used for beam and diffuse analyses.

FIG. 2 is an illustration of view factors.

FIG. 3 is an illustration of a model for beam shadowing based on virtual rays.

FIG. 4 is an illustration of the relationship between the modeling of beam shadows, view factors, and diffuse shadows.

FIGS. 5(A-B) illustrate a model for transmittance and other optical losses, as well as the main inputs and outputs for heat transfer equilibrium.

FIGS. 6(A-C) illustrate the virtual environment in which scenes are generated with PVs, B-type objects (for the surrounding infrastructure), and reference geometry.

FIGS. 7(A-C) illustrate reference geometry for angular sampling and for focusing space-sampling modeling resources in the virtual environment.

FIGS. 8(A-C) illustrate the integrated models of the overall framework and the main variables (Inputs, Intermediate, and Outputs).

FIG. 9 is an illustration of the various components used in the framework to model the anisotropic behavior of solar rays for different kinds of solar harvesting arrays.

FIG. 10 illustrates how B-Type objects are modeled and how they are characterized in space in terms of depth, which is critical to establish which objects may cast shadows onto others.

FIG. 11 illustrates an advanced depth-perception algorithm as pseudo-code.

FIGS. 12(A-C) illustrate the Ana-Iter & One-Ray approaches for modeling diffuse shadows.

FIGS. 13(A-B) illustrate the Pix-Flat approach for modeling diffuse shadows.

FIG. 14 shows the mapping of the 3D geometry of a scene onto a 2D flattened space as part of the Pix-Flat approach.

### DETAILED DESCRIPTION

Disclosed herein are systems and methods for simulating relevant phenomena for solar harvesting in environments surrounded by urban infrastructure. The simulations require the integration of modules for irradiance decomposition, view factors, beam and diffuse shadows, transmittance losses, heat transfer equilibrium, spectral and temperature-dependent PV efficiency, and a virtual environment that emulates urban infrastructure and receives weather and irradiation data are inputs to the simulation. In certain embodiments, the modelling may be inserted to account for changing positions of the Sun and changing weather conditions.

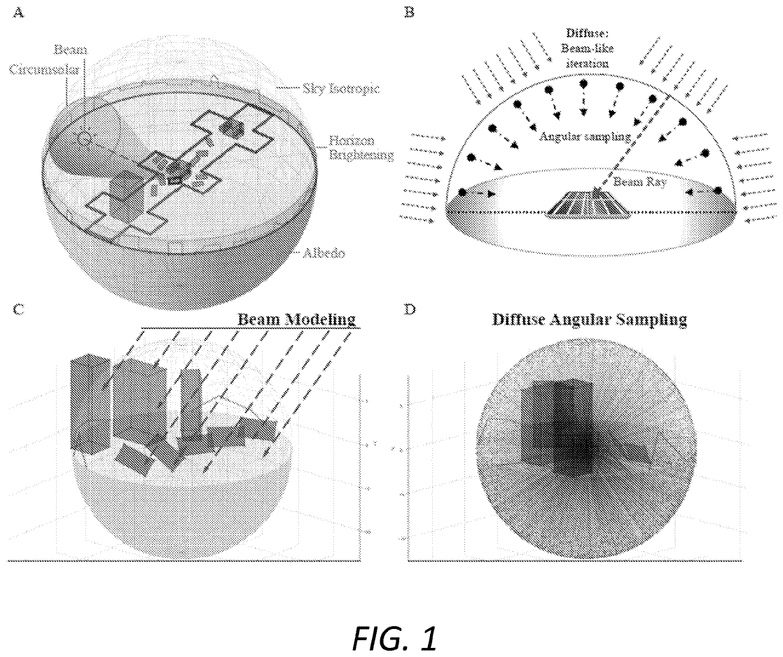

FIG. 1 shows the anisotropic components of solar irradiance conceptualized here using anisotropic sky models (A). Diffuse irradiance components are conceptualized as angular iterations of Beam-like rays (B). Beam irradiance (C) is treated as space-filling parallel rays in the direction of the Sun. This requires unbiased angular sampling procedures (D).

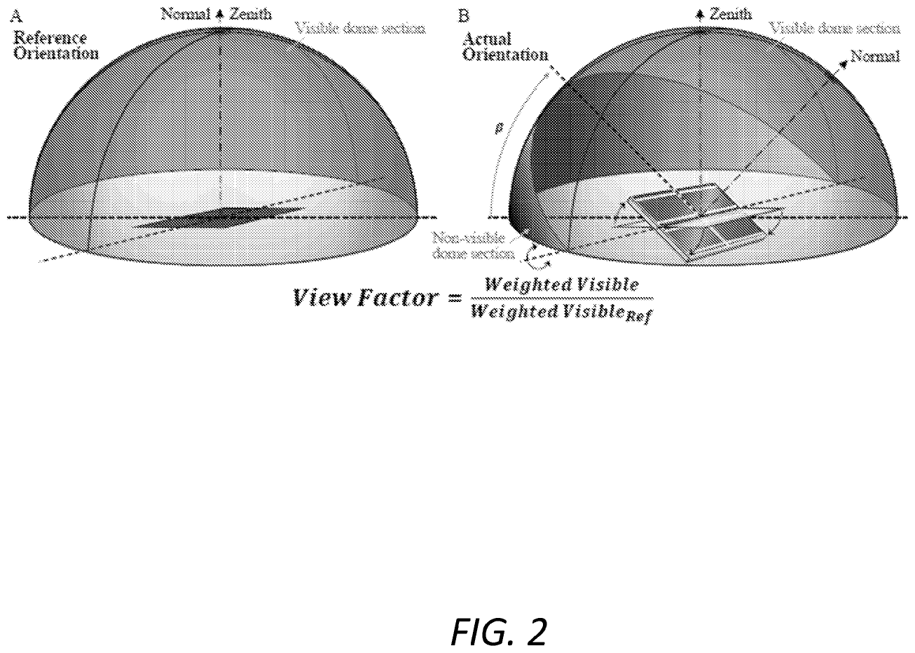

View factors are illustrated in FIG. 2. A view factor is the ratio between the weighted visible surface area of an angular region in the skydome (B), over the weighted visible surface area from a reference scenario with a baseline orientation (A), in this case, horizontal. Surface areas are weighted according to the Cosine effect. This example corresponds to the view Factor for the sky isotropic irradiance component, but view factors can be modeled for all anisotropic components.

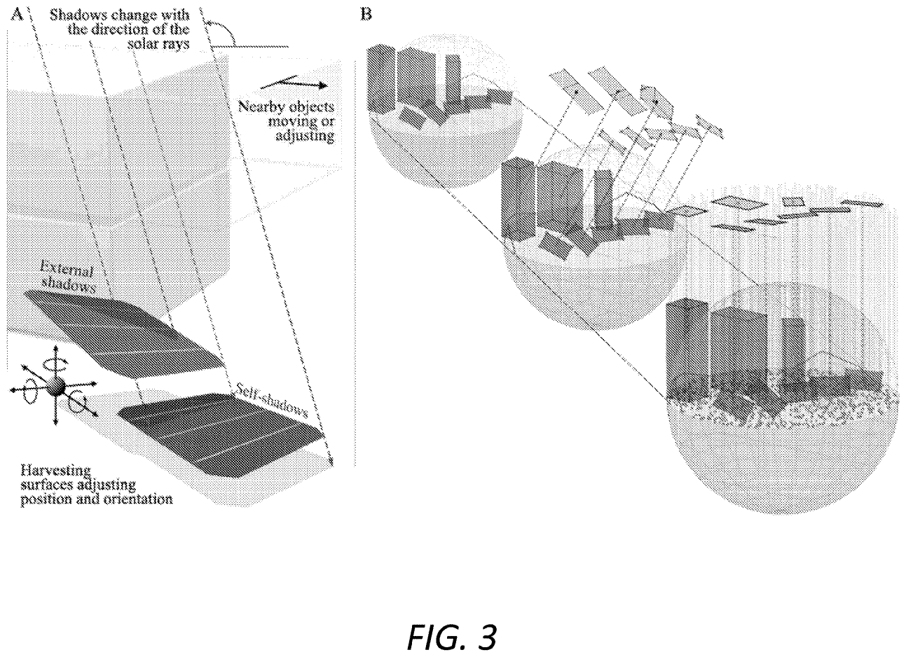

The model for beam shadowing is shown in FIG. 3. Shadows that hinder the harvesting performance (A) are dependent on solar position, the positions and orientations of the harvesting surfaces, the surrounding objects, and the distant silhouettes at the horizon. A virtual environment (B) is used to model beam shadowing, which involves projecting the virtual scene on a plane perpendicular to the beam rays, sampling the space of interest, and implementing an approach to check for obstructions or overlapping geometries.

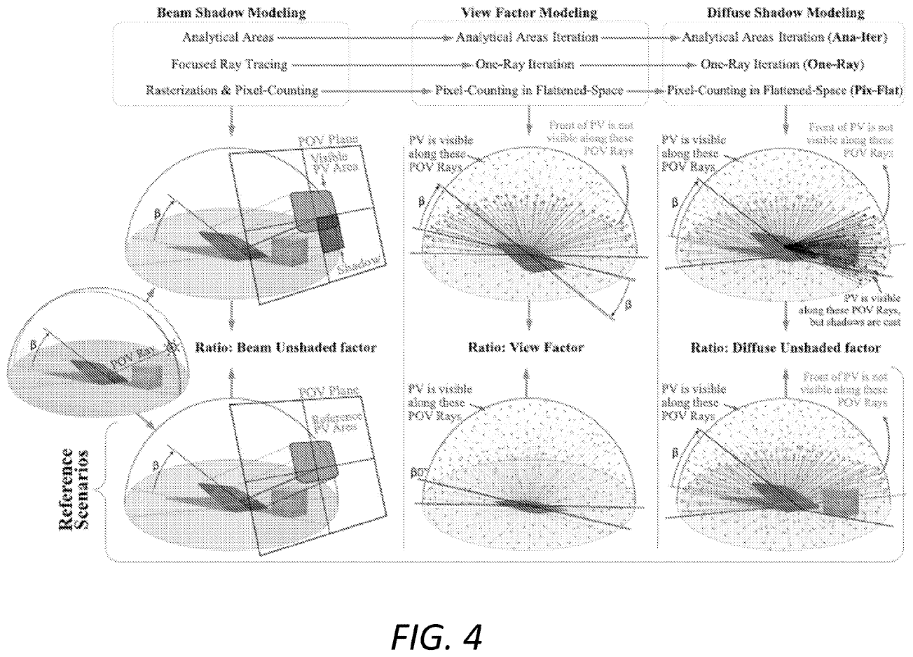

FIG. 4 shows the relationship between the modeling of beam shadows, view factors, and diffuse shadows. All three are used to calculate how much irradiance is available to a given surface, involving beam radiation for beam shadows and diffuse radiation for both view factors and diffuse shadows. All three are ratios comparing an actual situation to reference situations. This involves ignoring shadows, in the case of shadow modeling, or using equivalent but horizontal surfaces in the case of view factors.

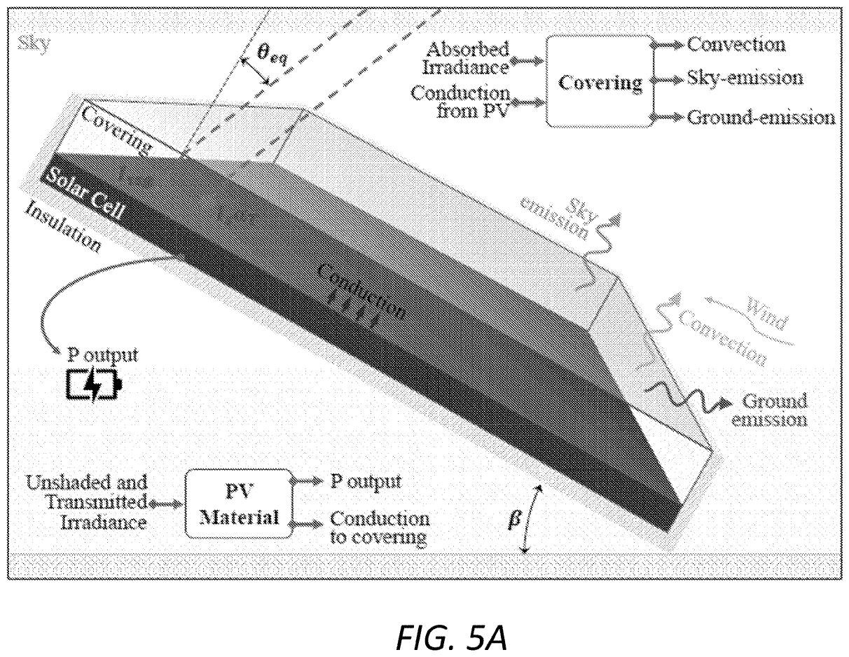

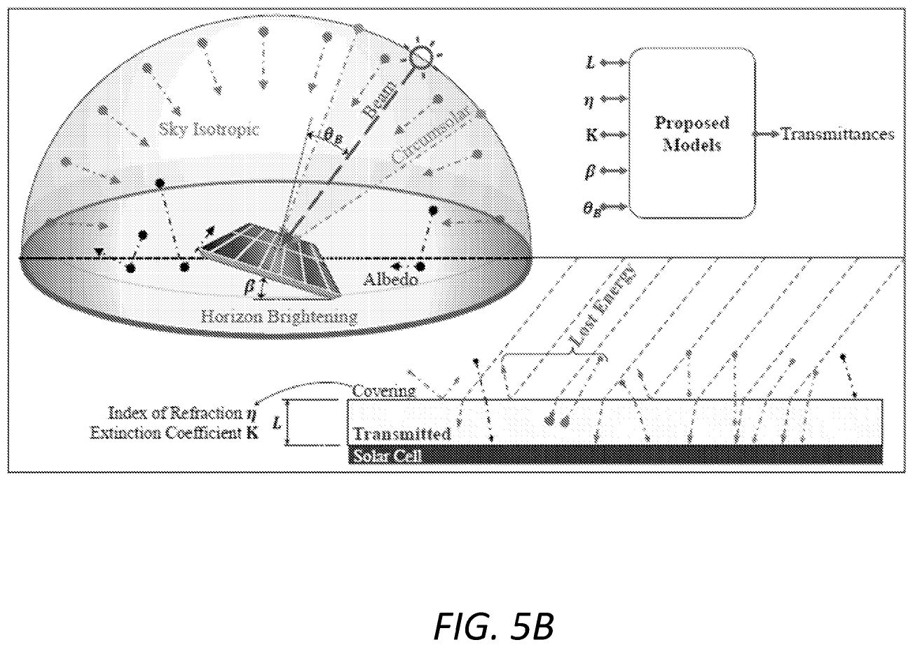

FIG. 5 shows a model for transmittance losses. FIG. 5A shows an Energy balance and heat transfer scheme for a PV-Covering (i.e., a photovoltaic surface with a semitransparent protective covering) system assumed to be in equilibrium. FIG. 5B shows a general scheme of the anisotropic radiation components (beam, circumsolar, sky isotropic, horizon brightening, and albedo) in relation to a solar panel with a given angular position. Modeling the transmittance of these components as functions of the beam incidence, panel inclination, covering thickness, index of refraction, and extinction coefficient allows estimating the optical losses in energy assessments. These losses are due to some of the incoming rays being absorbed in the protecting covering or being reflected away before reaching the photovoltaic material.

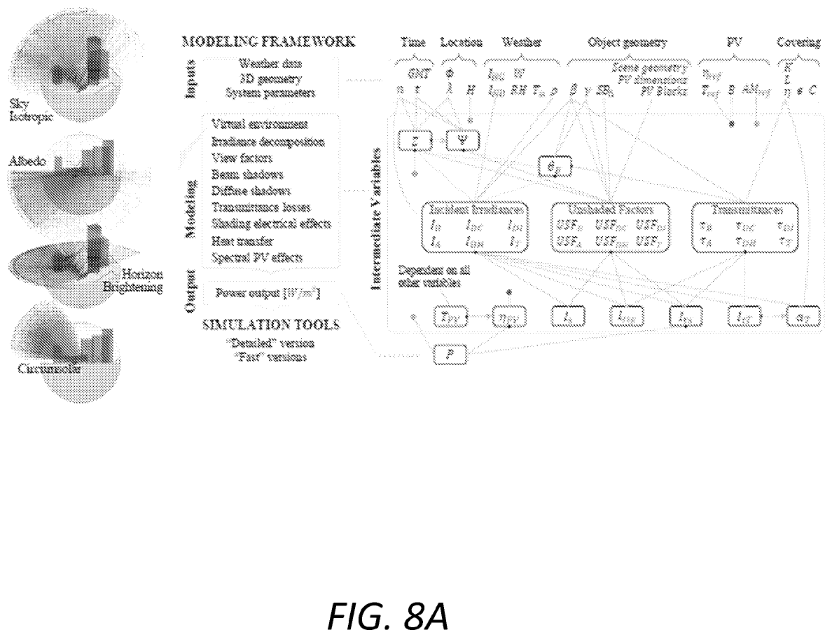

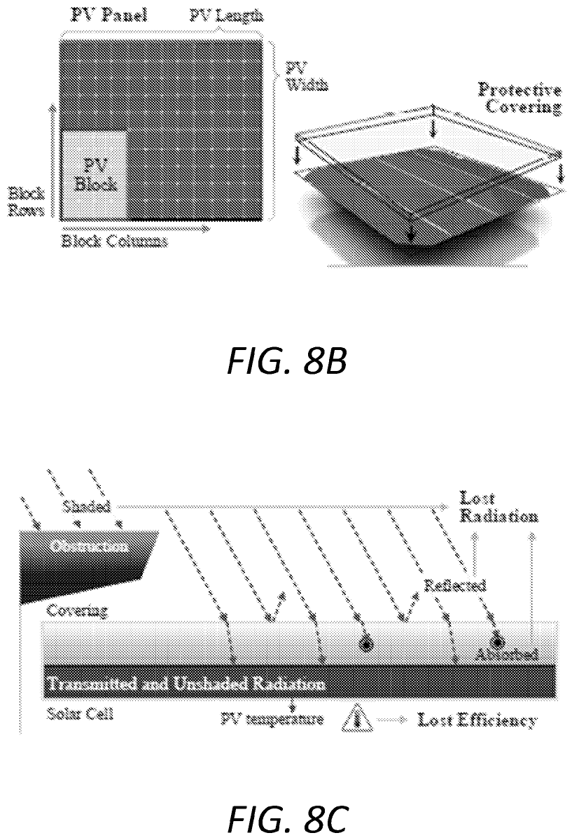

The manner in which the models of the simulation are integrated and how their functionalities are extended and fine-tuned will now be described. The usable energy that can be harvested in urban environments depends on complex solar radiation interactions, so to capture the relevant dynamics of these phenomena the modules rely on the modeling framework. The framework is visually described in FIGS. 8(A-C), which list the main inputs, modelling steps, and outputs. FIG. 8A (left) illustrates how the 3D geometry is extracted from real-world locations, while FIG. 8A (right) shows the interdependencies between the main variables. FIG. 8B shows important characteristics related to solar panels and FIG. 8C illustrates the main energy losses.

### Modelling Framework

The relationships between the classified input parameters, the main intermediate variables, and the output (Power Output, P) are illustrated schematically in FIG. 8A.

Weather data. Openly available datasets can be used to obtain local weather data. For example, NREL's “National Solar Radiation Database” (NSRDB) can be used for locations in the Americas. For locations in other continents, the “PVGIS Photovoltaic Geographical Information System” and the “POWER Data Access Viewer” can both be used to obtain the site-specific data required. Weather and solar radiation measurements are obtained for every sampled time step, including the Horizontal Global Irradiance (I_{HG}), Horizontal Diffuse Irradiance (I_{HD}), Horizontal Beam Irradiance (I_{HB}), ambient Temperature (Tₐ), wind speed (W in m/s), and relative humidity (RH). If two of these irradiances are known, the third one can be directly calculated. However, this information is not always available and it is more common to have only the I_{HG} values. For these cases, although a considerably larger uncertainty is expected, partition models can be used to decompose the Horizontal Global Irradiance into the Beam and Diffuse components. Also, if detailed ambient temperature data is not available, Tₐ profiles can be approximated with models that only require basic average metrics, like minimum and maximum temperature and day length. In this step and throughout the whole framework, all irradiances are in W/m², all Temperatures in Kelvin, and all angles in radians.

Solar position. The solar Zenith angle (Z) and the clockwise Azimuth angle (ψ, measured from the North) can be calculated by means well known in the art. For this purpose, the Earth's Declination (δ) is defined by the Equation Of Time, the Solar Time, and the Hour Angle (ω). In the framework shown in FIG. 8A, n is the day number in the year, t is the Civil Time, λ and φ are the Longitude and Latitude angles, respectively, and GMT is the hour difference from Greenwich Mean Time.

Extraterrestrial Irradiance is defined as the Horizontal Extraterrestrial Irradiance (I_{HE}).

Clearness index is a measure for how clear the atmosphere is.

Photovoltaic Spectral Response. The Air Mass (AM) is the distance that solar radiation has to go through in the atmosphere before reaching the harvesting surfaces, and this affects how much of the incoming irradiance can be absorbed by a given photovoltaic material. This phenomenon is captured by the spectral response (M, also called Air Mass Modifier), which is determined on a case-by-case basis for various types of solar cells. M is a function of the Absolute Air Mass, which is adjusted for the relative air pressure. The relative air pressure depends on the Altitude Above Sea Level. To use the spectral response for power estimations, it is defined in relative terms (M/M_{ref}), where M_{ref} is the reference spectral response corresponding to a reference Air Mass (AM_{ref}).

Dew-point Temperature The Dew-point temperature (T_{dew}) depends on the Relative Humidity and ambient Temperature.

Cloud coverage The Cloud coverage proportion can be approximated based on the Clearness index.

Sky Temperature The Sky temperature (T_{sky}) is approximated based on the Dew-point Temperature, ambient temperature, and cloud coverage

Beam Incidence Angle The Beam Incidence angle (θ_{B}) (i.e., the angle between the Beam rays and the normal to a harvesting surface), is calculated based on the solar position and the orientation of the solar harvesting surface. It is a function of the inclination angle of the harvesting surface, measured from the horizontal, and its clockwise azimuth-wise orientation measured from the North.

Anisotropic Incident Irradiances. Using Anisotropic transposition models, the incoming solar radiation is decomposed into different incident irradiances corresponding to Beam (I_{B}), Sky Isotropic (I_{DI}), Albedo (I_{A}), Horizon Brightening (I_{DH}), and Circumsolar (I_{DC}). The models take horizontal irradiances and angular orientations as inputs and estimate the intensity with which each anisotropic component reaches unshaded surface with any freely-defined orientation.

Anisotropic Transmittance Factors. General diffuse transmittance models are used to obtain transmittance factors for Sky Isotropic irradiance (τ_{D}), Albedo (τ_{A}), Horizon Brightening (conceptualized as a ring, τ_{DHring}, or a band, τ_{DHband}), and Circumsolar (τ_{DC}). The covering characteristics can be specified (i.e., Thickness (L), Extinction Coefficient (K), and Refraction Index (η).

Total Absorptance refers to the proportion of incoming radiation that is absorbed and dissipated in the form of heat in the protective covering of solar panels. For this purpose, the Total Transmittance (τ_{T}) is defined as the ratio between the Total Transmitted Irradiance (I_{τ}_{_{T}}) and the Total incident Irradiance (I_{T}).

Unshaded Factors. To simulate relevant shadow phenomena, the local scene that surrounds the harvesting surfaces can be recreated in a virtual environment. Several approaches (discussed later herein) can be used to model Beam shadows and obtain the corresponding Beam Unshaded Factors (USF_{B}) and the number of shaded PV Blocks (NSB) in every solar panel. An “Unshaded Factor” is the portion of a solar harvesting surface that is visible (unobstructed), divided by the total surface from the point of view of Beam rays. USF_{B}=0.3, for example, implies that 70% of the solar harvesting surface is obstructed by shadows regarding Beam irradiance. Solar cells within a solar panel are usually grouped into “PV Blocks”, which are contiguous cells connected in series and protected by a bypass diode. When the unshaded portion of a PV Block is less than a given threshold (SB_{Δ}), that Block is considered a “shaded block” (SB), which is important for electrical mismatch implications and can lead to additional energy losses.

Additionally, extended approaches that can be used to model Diffuse Unshaded Factors for Sky Isotropic (USF_{DI}), Albedo (USF_{A}), Horizon Brightening (USF_{DH}), and Circumsolar (USF_{DC}) are introduced. The USF of a Diffuse irradiance component is the amount of that component that is accessible for harvesting from a given surface, calculated as a proportion of the amount that would be accessible in the same scenario but disregarding shadows. USF_{DI}=0.6, for example, means that 40% of the Sky Isotropic irradiance is obstructed by diffuse shadows cast by surrounding objects.

Available Irradiances from Shading Effect Models Once the total amount of irradiance that is incident on a surface is calculated, “Shading Effect Models” allow estimating the effect of shadows on the effective irradiance that is expected to be available for power generation. From these models, the total available irradiances can be calculated at different stages: 1) the unobstructed Irradiance reaching the surface of the solar harvesting device (Iₛ); 2) after passing through the covering layer (I_{τsg}); and 3) after considering interactions with the PV Block diode connectors (I_{τs}). As schematically illustrated in FIG. 8A, Iₛ accounts for the transposed and aggregated incident irradiances, as well as the corresponding Unshaded Factors. Iₛ represents the maximum power that can be harvested by a generic surface. In addition to that, I_{τsg} considers transmittance losses, so it represents the maximum available power after going through the covering layer of some sort of solar device. For theoretical consistency, every irradiance component is multiplied by its corresponding Unshaded and transmittance factors. Furthermore, I_{τs} considers incident irradiances, Unshaded Factors, transmittance losses, and an experimentally-adjusted factor that accounts for electrical losses in photovoltaic devices. These losses are a function of the number of shaded PV Blocks (NSB) compared to the total number of Blocks (NB) in a panel. This PV Block consideration implies that, regardless of its area, a Beam shadow causes greater energy losses if it involves more shaded Blocks.

Heat Transfer Model. FIG. 5A illustrates the general energy balance and heat transfer analysis. The energy balance is based on a two-body system, namely, the photovoltaic material and the semitransparent covering layer. The purpose of this analysis is to calculate the temperature at the PV layer (T_{PV}). This system is assumed to be thermally insulated around the edges and on the opposite facing side. Also, to approximate the average temperatures, this model assumes that temperature is uniformly distributed in both layers. At any given time step, the system is assumed to be in equilibrium, so the inputs must be equal to the outputs as much as possible.

Power Output. The electrical Power output depends on the total unshaded and transmitted irradiance (taking PV Block considerations into account), the PV Efficiency (η_{PV}) and the relative spectral response (M/M_{ref}).

Energy Output. Lastly, the Energy Output (E in Wh/m²) can be numerically integrated for every time step and multiplied by the time delta (Δt). The total number of time steps N and the time delta depend on the desired total time length and resolution. For instance, for estimating the annual Energy Output, if the time resolution is Δt=0.5 h, then N=17520.

### Virtual Environment

An essential aspect of the modeling capabilities disclosed herein is a virtual environment that allows generating virtual scenes and interacting with them. The virtual environment functionalities are developed using basic functions from the Matplotlib library for visualization and Numpy for geometric constructions and space manipulations.

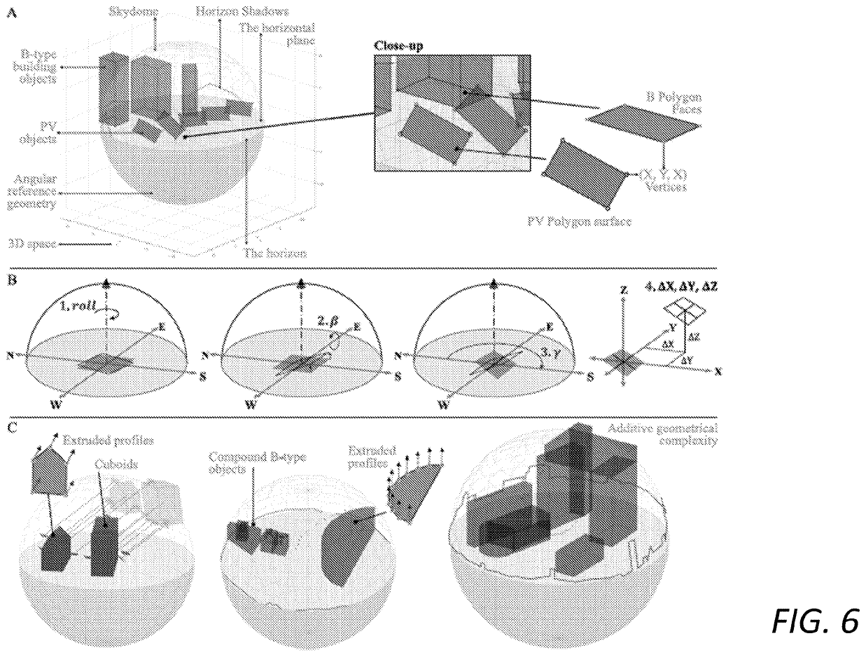

Virtual scenes, an example of which is shown in FIG. 6, are defined with PV objects (i.e., solar harvesting surfaces), B-type objects (Bs, i.e., for approximating urban infrastructure), Horizon Shadows (i.e., urban or topographical silhouettes at the horizon), and reference geometry. PVs are flat polygon surfaces and Bs are volumes bounded by polygon faces, as shown in FIG. 6A. Every polygon is characterized by four vertices with (X, Y, Z) coordinates. PV objects may represent solar panels or generic solar harvesting surfaces, like a window, a roof, part of a facade, or a land plot for urban farming. PVs can have any arbitrary length, width, number of sub-modules (i.e., “PV Blocks”) represented by the number of Block columns and rows, any roll angle (about an axis perpendicular to the PV surface at its center), inclination from the horizontal, and azimuth orientation (the North-clockwise direction of the normal vector). Similarly, Bs can have any width, length, height, and orientation.

The polygons from all objects are first generated at the center of the scene and with “neutral” orientation, namely, 0° roll, inclination, and azimuth. Using rotation matrices, as shown in FIG. 6B, every vertex is rotated according to the roll angle first, the inclination from the horizontal second, and the azimuth orientation third. Lastly, the 3D coordinates of the object's center are added to the vertex coordinates. This way, every object in the scene is freely oriented and displaced to any desired specification, and the parameters involved can be adjusted as a function of time to emulate dynamic behaviors. As shown in FIG. 6C, B-type objects can be generated as cuboids (i.e., rectangular prisms), or convex profiles extruded in any direction.

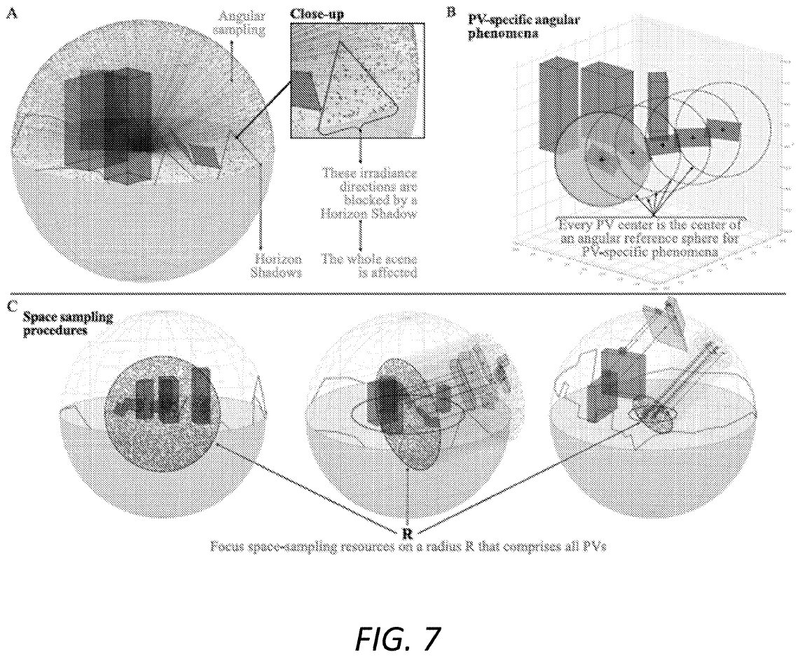

Intricate urban geometries can be progressively generated by using compound arrangements of these objects. Reference geometry (FIG. 6A) includes the horizontal plane, the horizon (as a ring), and a spherical surface as an angular reference of the sky and ground domes. This sphere is useful for visualizing Diffuse radiation phenomena, which involves angular sampling procedures. For phenomena that affect the whole scene, as with Horizon Shadows, one reference sphere is centered ideally with respect to the group of PV objects. Distant objects and surrounding topography can be represented as Horizon Shadows projected onto this spherical sky surface. Horizon Shadows, as shown in FIG. 7A, are defined as spherical surfaces delimited by sets of (Azimuth, Elevation) coordinates. These projected shapes cast shadows at an angular level. Namely, if irradiance from a given Point Of View (POV) direction falls within a Horizon Shadow, all radiation from that POV is considered blocked. This is analogous to when the solar disc falls behind the top of a mountain and objects in the local scene can no longer access Beam radiation, regardless of their local positions and orientations.

For angular sampling procedures that depend on the specific position and orientation of PVs, as shown in FIG. 7B, reference geometry is generated at the center of every PV object. For instance, the orientation of every PV is taken into account for modeling View Factors and transmittance losses. Additionally, space sampling procedures, like simulating Beam irradiance with stochastic space-filling rays, as shown in FIG. 7C, can be limited to an area of interest with radius R to focus the modeling efforts and resources. R should contain all PV objects, but not necessarily all B-type objects. This is because, although only rays that go through a sphere with radius R are generated, these rays can extend indefinitely and interact with infrastructure that is outside such sphere.

The inputs to the simulation include the weather data, as shown in FIG. 8A, which comprises horizontal global irradiance (I_{HG}), horizontal beam irradiance (I_{HB}), wind speed (W), relative humidity (RH), ambient temperature (Tₐ), and albedo coefficient (ρ).

The inputs further include 3D geometrical data comprising B-type objects, horizon shadows, PV dimensions and block arrangement, as shown in FIG. 8B, PV inclination (β), PV azimuthal orientation (γ) and the threshold for considering a PV Block shaded (SB_{Δ}), parameters related to time (day number (n), hour offset from Greenwich Mean Time (GMT) and civil time (t)) and location (latitude (φ), longitude (γ) and altitude above sea level (H)), solar panel specifications (baseline PV efficiency (η_{ref}) measured at a temperature (T_{ref}) and air mass (AM_{ref}) and temperature coefficient (B)) and protective covering characteristics (extinction coefficient (K), thickness (L), refraction index (η), emissivity (ϵ), and thermal conductivity (C).

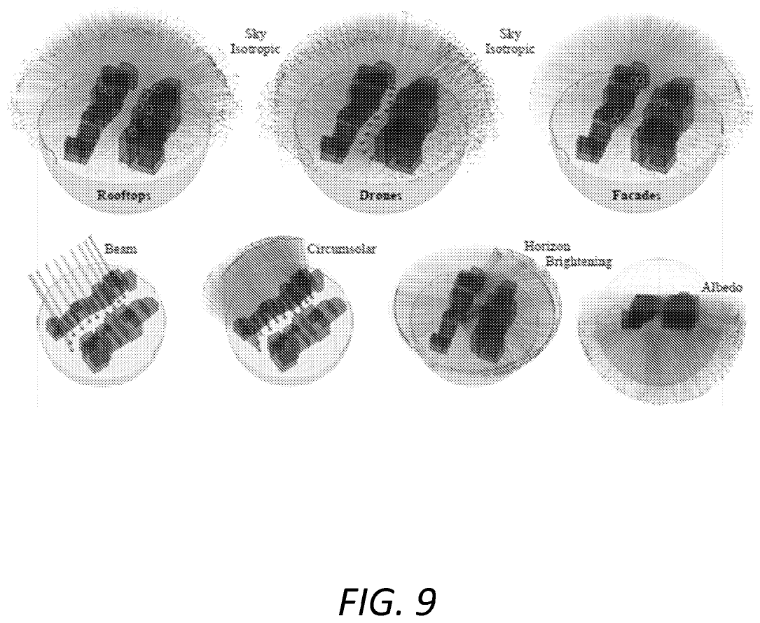

To estimate power output (P), input solar irradiance is conceptualized as the aggregated anisotropic behavior of numerous solar rays and decomposed into five components: Beam, Sky Isotropic, Albedo, Horizon Brightening, and Circumsolar, as shown in FIG. 9. Once solar irradiance is decomposed.

A key consideration in the modeling framework is estimating how much of each irradiance component would reach the harvesting surfaces based on their freely-defined orientations. View factors are mathematical constructs that allow estimating the incident radiation on surfaces with any orientation based on more widely available horizontal measurements. Aside from view factors, as both beam and diffuse irradiance components interact with the surrounding infrastructure, it is important to take beam and diffuse shadows into account to estimate how much of each and every component will effectively reach the harvesting surfaces unobstructed.

Additionally, solar panels use semi-transparent protective coverings, such as thin sheets of glass or polycarbonate, which can decrease usable energy because some rays are absorbed or reflected away from the photovoltaic material. Only the radiation that is effectively transmitted to the PV material can be directly useful for power generation. Besides reducing the total irradiance that reaches the harvesting surfaces, shadows can also have electrical mismatch effects that depend on the proportion of shaded PV Blocks (i.e., groups of cells connected in series and protected by a bypass diode). Other important sources of energy losses are PV efficiency dependencies on the solar cells' temperature and spectral shifts in solar radiation throughout the day.

Accordingly, irradiance decomposition, view factors, beam and diffuse shadows, transmittance, and heat transfer are the main components integrated in the modeling framework, as shown in FIG. 8A. Some of these potential sources of energy losses are illustrated in FIG. 8C. The interdependencies between inputs, intermediate variables, and outputs are mapped in FIG. 8A (right). Regarding angular references, the main variables are solar zenith (Z), solar azimuth (ψ), and solar incidence angle (θ_{B}). Other important intermediate variables include the incident irradiances (I), Unshaded Factors (USF), transmittance factors (τ), and absorptance (α); with the subscripts B, DC, DI, A, SH and T respectively corresponding to Beam, Circumsolar, sky Isotropic, albedo, horizon brightening, and total. The more comprehensive total irradiances are the total irradiance reaching the device (I_{S}), the total irradiance passing through the covering layer (I_{τSG}), the total transmitted irradiance with all shadow considerations (I_{τS}), and the total transmitted irradiance with no shadow considerations (I_{τT}). The PV efficiency (η_{PV}) is linked to the PV temperature (T_{PV}), and T_{PV} and P are directly or indirectly linked to all other variables and inputs.

The parameters and internal modules of the modeling framework can be fine-tuned to propose “Fast” and “Detailed” simulation tool versions. There are notable trade-offs between accuracy and computational cost, especially regarding shadow modeling. This is why developing both Fast and Detailed versions is valuable to provide greater modeling versatility. For example, optimization schemes to determine the positions and orientations of solar panels surrounded by buildings and placed at plazas, rooftops, or facades will likely benefit from the capability to test thousands of configurations with fast approximations first and then use more detailed and accurate estimations toward the end of the design process or to evaluate the performance of the final design. Improving the overall run-time efficiency is important due to the large number of simulations that are often key in iterative or heuristic optimizations, which may be used in the future to design and control dense groups of solar harvesting devices with complex interactions.

As shadow modeling is particularly computationally intensive compared to the other modeling steps, the approaches used for shadow modeling are some of the main distinctions between the Fast and Detailed versions. For computing beam shadows, all versions use the analytical areas approach because it is considerably faster than the tested alternatives (two to three orders of magnitude faster) while also achieving competitive accuracy and stability. Regarding the Diffuse shadow modeling approaches that are disclosed; later herein, the Fast versions of the tool use the most efficient approach (i.e., “Pix-Flat”) at a close to 5% convergence level, while the Detailed version uses “Ana-Iter”, as this approach appears to consistently achieve 1% convergence levels in terms of target values of Unshaded Factors. The Ana-Iter approach is well-suited for scenarios that demand superior precision in shadow modeling, while the Pix-Flat approach appears to pose a compelling compromise between accuracy and efficiency. Thus, the Detailed tool implements Ana-Iter with direction sampling resolutions of 3750, 10000, 3750, and 750, respectively for the sky isotropic, albedo, horizon brightening, and circumsolar irradiance components. The Fast tool version computes diffuse shadows by implementing the Pix-Flat approach at a 0.5 angular resolution, which is close to its 5% convergence level while avoiding its notable run-time spike at more demanding resolutions.

To allow for considerably more intricate and realistic urban infrastructure, the methods disclosed herein overcomes several limitations on how B-type objects are represented and mapped for recreating buildings. B-type objects can be generated as cuboids (i.e., rectangular prisms) or convex profiles extruded in any direction. Also, B-type objects can be set in any position or orientation, their volumes can partially overlap without causing instabilities, and they can be stacked together to progressively generate intricate urban geometries with compound arrangements, as shown in FIG. 6C, which shows B-type objects as extruded profiles and additive geometrical complexity.

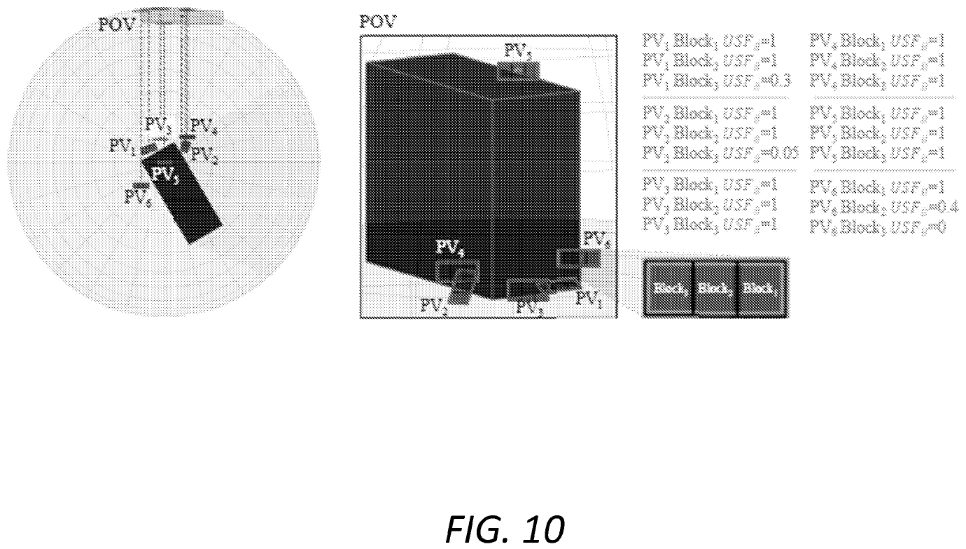

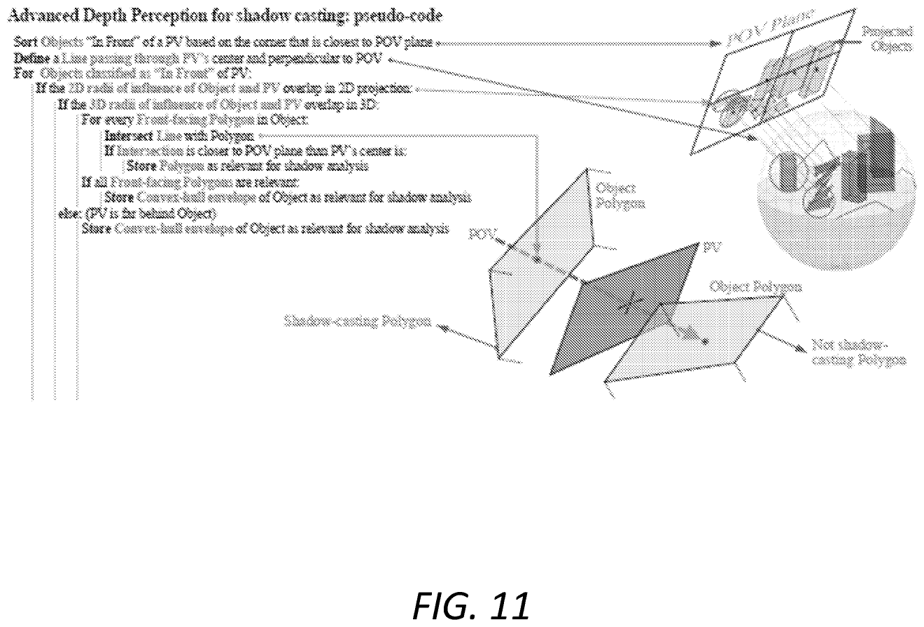

Another limitation addressed here is how Ana (for beam shadows) and Ana-Iter (for diffuse shadows) perceive the relative distances between objects based on their 3D centroids. Object sorting based on depth perception from the Point Of View (POV) of the solar rays is crucial to properly determine which objects can cast shadows onto others. However, if a B-type object is too large relative to its distance from nearby PVs, its centroid does not always provide enough information to reliably identify which neighboring PVs it can obstruct. FIG. 10 shows a challenging example in terms of object depth perception being decisive for properly estimating unshaded factors. This example is designed to be particularly challenging in this regard, where depth-based object sorting can directly determine unshaded factors and where centroids do not provide enough information. For instance, if PV₆ is sorted as being in front of the building, all of its unshaded factors would erroneously be set to 1. To mitigate the occurrence of similar situations, B-type objects could be broken into contiguous smaller components so that their centroids carry more meaningful information about their depth locations. Based on this strategy, the closer PVs are to a large building object, the more important it becomes to split that region into more B-type objects. However, this strategy increases the number of B-type objects that have to be processed by shadow modeling algorithms, which can be less efficient on the simulation side and more cumbersome on the CAD-modeling human side. This limitation is addressed here by developing a more advanced depth-perception algorithm detailed in FIG. 11, which illustrates pseudo-code of the new algorithm for depth perception and object sorting from the point-of-view of rays. This procedure identifies the polygon faces of B-type objects that may cast shadows on a given PV surface. If all the front-facing faces of an object are relevant, or if the PV is far enough behind the object, then the convex hull polygon of the whole projected object is stored. The polygons identified as being “relevant” are stored for subsequent detailed shadow-casting analysis. This novel approach, which eliminates the need for recursive object-splitting, effectively sorts the shadow-casting surfaces in the example shown in FIG. 10. As a result, the displayed unshaded factors correctly correspond to the 3D scene.

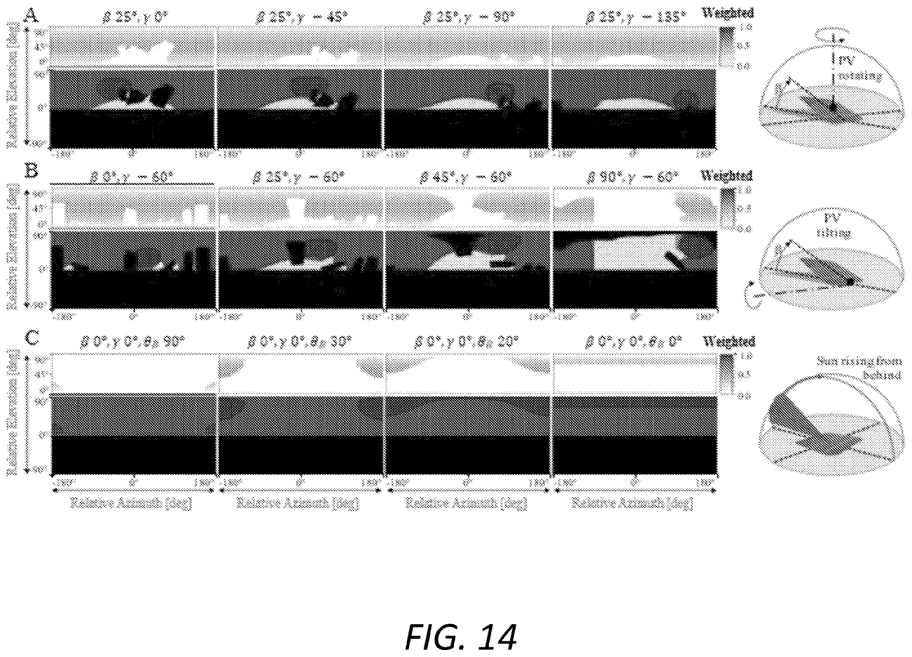

An important efficiency and stability limitation is how Pix-Flat (for Fast Diffuse shadows) represents objects in 3D space before mapping them on angular flattened-space. Pix-Flat can use a fixed number of uniformly-distributed points to represent every straight segment of a virtual object. These (X,Y,Z) points are then translated into angular coordinates relative to the harvesting surfaces. In the process, the mapped line segments can become curved due to dilation effects, which is why the number of points per line determines how well this curvature can be approximated. While using 10 points per line as a fixed parameter appears to be enough for representing simple urban scenes, this can be a limitation for more intricate infrastructure. For example, if a B-type object is relatively large and close to a PV, its curved geometry can span a large angular region in flattened-space (FIG. 14), which requires more points per line to capture its curvature accurately. Conversely, if a B-type object is far away or relatively small, then its curvature can be captured with fewer edge splits and so a fixed number of points per line could be unnecessarily costly. This limitation is overcome herein by developing an adaptive strategy, namely, the number of points per line depends on the relative angular span of every line segment. This way, every mapped line segment between two contiguous points has an angular span smaller or equal to an angle delta parameter. This parameter is optimized using 5 simulated scenarios and comparing Pix-Flat USF estimations to using Ana-Iter at a 1% convergence level (assumed here to be ground truths). A 2-degree angle delta is chosen because it is shown to be a good trade-off between curvature-mapping stability and computational cost.

The accuracy of this adaptive geometry-mapping procedure appears to be more stable regardless of the intricacy of the surrounding infrastructure or the relative size and proximity of B-type objects. The extended capabilities presented here, including enhanced additive complexity, more advanced depth perception, and spatial-to-angular mapping, improve the simulation tools in terms of practicality and overall efficiency, especially while simulating intricate virtual scenes. Beyond shadow modeling, heat transfer equilibrium presents another opportunity for leveraging the trade-offs between accuracy and efficiency. The heat transfer equilibrium analysis involves implementing a bisection iterative procedure to find the total absorptance, and a fixed-point iteration method to solve a two-equation coupled system. Using these numerical procedures to calculate T_{PV} is referred to here as the “Full Heat Transfer” model. This model is used in the main “Detailed” and “Fast” tool versions. Seeking to explore further gains in run-time efficiency, additional fast versions of the tool are disclosed. These versions approximate T_{PV} using analytical models with considerably lower computational cost and greater ease of implementation.

The first one is the “Ross-Smokler Heat Transfer” model, expressed in Eq. (1).

$${T}_{PV ( Ross - Smokler )} = {T}_{a} + 0.0 \; 35 {I}_{S} \qquad ( 1 )$$

The second one, expressed in Eq. (2) is referred to as “Sandia Heat Transfer”, and is a model used by the HelioScope tool and developed by Sandia National Labs. The “close-roof mount” parameters are chosen because they more closely resemble the assumptions made in Full Heat Transfer, such as PVs being thermally insulated on the back.

$${T}_{PV ( Sandia )} = {I}_{S} {e}^{- ( 2.98 + 0.0471 W )} + {T}_{a} + \frac{{I}_{S}}{1000 W / {m}^{2}} \qquad ( 2 )$$

Lastly, the “Diffusion Heat Transfer” model is used in HelioScope and PV_{syst}. It is presented in Eq (3) with parameters based on “Flush” mount type.

$${T}_{PV ( Diffusion )} = \frac{0.9 {I}_{S}}{29} ( 1 - {η}_{ref} ) + {T}_{a} + \frac{{I}_{S}}{1000 W / {m}^{2}} \qquad ( 3 )$$

In summary, the geometric modeling capabilities of the tools are improved with greater flexibility for B-type object representations. Anisotropic irradiance decomposition and view factors for transposition are based on the Perez model. Transmittance factors are calculated with a general model. Beam shadows are computed with the Ana approach and with enhanced depth perception. Diffuse shadows for the detailed tool are computed with the Ana-Iter approach discussed later herein, using the resolutions for 1% convergence levels, and with improved depth perception. Diffuse shadows for the fast tools are computed with the Pix-Flat approach disclosed later herein, using a 0.5-deg angular resolution for rasterizing flattened-space and a 2-deg angle delta for the new adaptive points-per-line mapping functionality. Additionally, the fast tools can use the full heat transfer numerical model or various analytical approximations (i.e., Ross-Smokler, Sandia, or Diffusion).

Summarizing a first aspect of the invention, disclosed herein is a novel model that captures relevant phenomena for solar harvesting in environments surrounded by urban infrastructure, which necessitates integrating weather data, urban setting geometry, irradiance decomposition (FIG. 1), view factors (FIG. 2), beam (FIG. 3) and diffuse shadows (FIG. 4), transmittance losses (FIG. 5B), PV spectral response and efficiency, and heat transfer equilibrium (FIG. 5A) in a virtual environment containing virtual scenes (FIG. 6). These models were used to build simulations, as shown in FIG. 8A.

The second aspect of the invention is directed to the modelling of diffuse shadows, which are a component of the overall modelling framework. Part of the theoretical backbone of the disclosed methods is the relationship between the modeling of beam shadows, view factors, and diffuse shadows. All three are used to calculate how much irradiance is available to a given surface, involving beam radiation for beam shadows and diffuse radiation for both view factors and diffuse shadows. All three are ratios comparing an actual situation to reference situations which involve ignoring shadows, in the case of shadow modeling, or involve using equivalent but horizontal surfaces in the case of view factors.

FIG. 4 illustrates this relationship with an example of a single solar harvesting surface with a β inclination. For Beam shadows, the scene is projected onto a plane that is aligned with the Point Of View (POV) of the Sun (i.e., solar azimuth and elevation). The projected harvesting area that is visible (i.e., front-facing and unobstructed by shadows) is calculated along with the visible area in a shadow-less reference scenario, and the ratio results in the beam unshaded factor (USF_{B}). The main challenge in beam shadow modeling is conducting an accurate and efficient spatial sampling of the projected scene to characterize the visible areas. In the case of view factors, the objective is to calculate how much of the diffuse irradiance is available to a harvesting surface in any orientation compared to the same surface but in a Reference orientation (e.g., horizontal). This can be achieved by sampling a set of POV directions to represent the incoming diffuse rays, and then aggregating the visible harvesting area from each POV. The challenge is sampling the angular regions that correspond to the different components of diffuse radiation (sky isotropic, albedo, horizon brightening, and Circumsolar) by using delimited but unbiased POV distributions and considering the “Cosine Effect” (i.e., the cosine of the incidence angle). View factor modeling deals with angular resolution but not with spatial resolution because the harvesting surface is reduced to a singularity, namely, a dimensionless point at the center.

Similar to view factor modeling, the objective of diffuse shadow modeling is estimating how much of the diffuse irradiance reaches a harvesting surface by finding the diffuse unshaded factors (USF). A diffuse USF is the proportion of irradiance that is available to a harvesting surface in the actual virtual scene compared to a reference virtual scene for which no shadows are accounted. For example, 60% sky isotropic USF means that 40% of the sky isotropic irradiance is blocked by diffuse shadows cast by surrounding objects. The challenge is twofold: a balanced and representative angular sampling of POVs that represent the diffuse irradiance components, and a sufficiently accurate spatial sampling that characterizes the shadows from every sampled POV. Thus, the modeling capabilities for beam shadows and view factors are used to build and verify the spatial and angular sampling capabilities of the diffuse shadow modeling approaches.

Beam shadow modeling approaches are used here as initial steps toward developing diffuse extended versions. Three beam approaches are selected: (1) “analytical areas”, which uses polygon projection, intersection, and merging to characterize the unshaded areas with the Shoelace Formula; (2) “focused ray tracing”, which uses a ray-tracing technique similar to Backward ray-tracing and which generates the rays directly on the PV surfaces; and (3) “rasterization and pixel-counting”, which projects and discretizes the scene using image processing rasterization techniques and counts the number of pixels of specific color values to approximate visible areas. The three approaches, listed at the top of FIG. 4, are developed for view factor modeling and then extended for diffuse shadow modeling: “Analytical Areas Iteration”, “One-Ray Iteration”, and “Pixel-Counting in Flattened-Space”.

### Angular Sampling: View Factor Modeling

View factor modeling is used to analyze how modified versions of beam shadow modeling approaches can be used to sample the angular space and characterize the diffuse radiation components. One important advantage of using view factors as theoretical intermediaries between beam and diffuse shadow modeling is that there are analytical expressions available for every component (i.e., sky Isotropic and albedo view factors, horizon brightening view factor conceptualized as a flat ring at the horizon, and circumsolar view factor, with β as the inclination angle of the harvesting surface and θ_{B} as beam incidence angle).

$${VF}_{DI} = \frac{1 + cos β}{2} \qquad ( 4 )$$

$${VF}_{A} = \frac{1 - cos β}{2} \qquad ( 5 )$$

$${VF}_{DH} = sin β \qquad ( 6 )$$

$${VF}_{DH} = \{ \begin{matrix}cos {θ}_{B} , & if {θ}_{B} < \frac{π}{2} - \frac{25 π}{180} \\ [ \frac{23}{10} - \frac{18 {θ}_{B}}{5 π} ] sin ( \frac{π}{4} - \frac{{θ}_{B}}{2} + \frac{25 π}{360} ) , & if {θ}_{B} ϵ [ \frac{π}{2} \pm \frac{25 π}{180} ] \\ 0 , & if {θ}_{B} > \frac{π}{2} + \frac{25 π}{180}\end{matrix} \qquad ( 7 )$$

These expressions are used to find target values that can then be compared to numerical estimates seeking to verify convergence. Three numerical approaches are developed, evaluated, and fine-tuned for view factor modeling: Analytical Areas Iteration (Ana-Iter), One-Ray Iteration (One-Ray), and Pixel-Counting in Flattened-Space (Pix-Flat). As shown in FIG. 4, a number of POV directions are stochastically sampled from the skydome within the angular boundaries of a given irradiance component. Two virtual scenes are generated: an empty space with a central PV in an arbitrary orientation, and an empty space with a central PV in a reference orientation. The visible PV area is calculated in both scenes for every POV. The view factor is the weighted sum of the visible areas from all the sampled POV directions in the actual scene over the weighted sum corresponding to the reference scene. The reference orientations are: horizontal (β=0°) for sky isotropic and albedo, vertical (β=90°) for horizon brightening, and normal beam incidence (θ_{B}=0°) for circumsolar.

In the Ana-Iter approach, the visible PV area is calculated analytically from every POV. Analytical areas already account for the incidence effects because projected areas become narrower as incidence increases, so the sum of these areas is already a weighted sum in terms of incidence.

In the One-Ray approach, one angular-sampling ray is generated at the center of every PV and in the direction of every POV. Then, the rays that reach the front of the harvesting surface are counted. Here, the Cosine Effect is taken into account by weighting every counted ray by the cosine of its incidence angle.

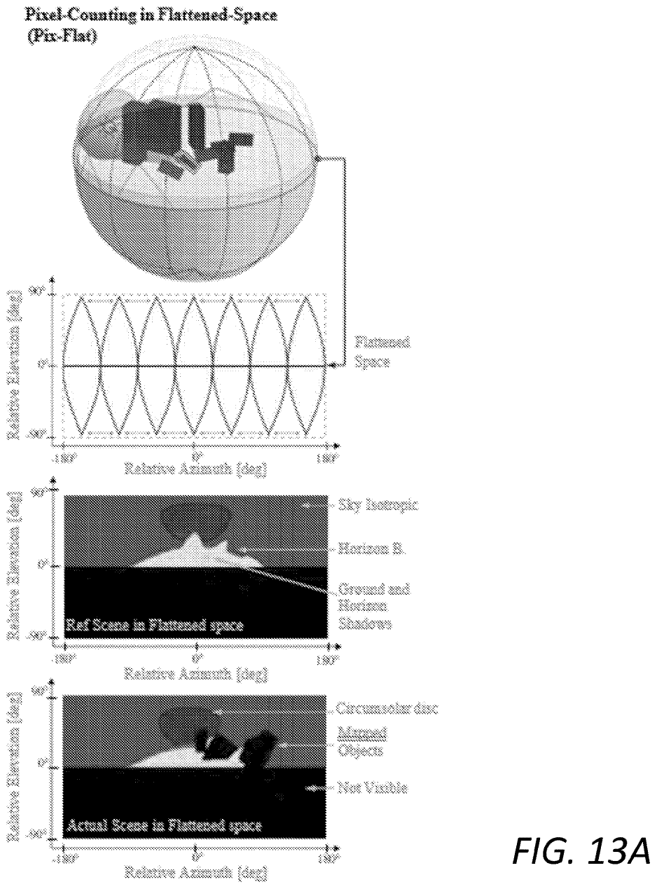

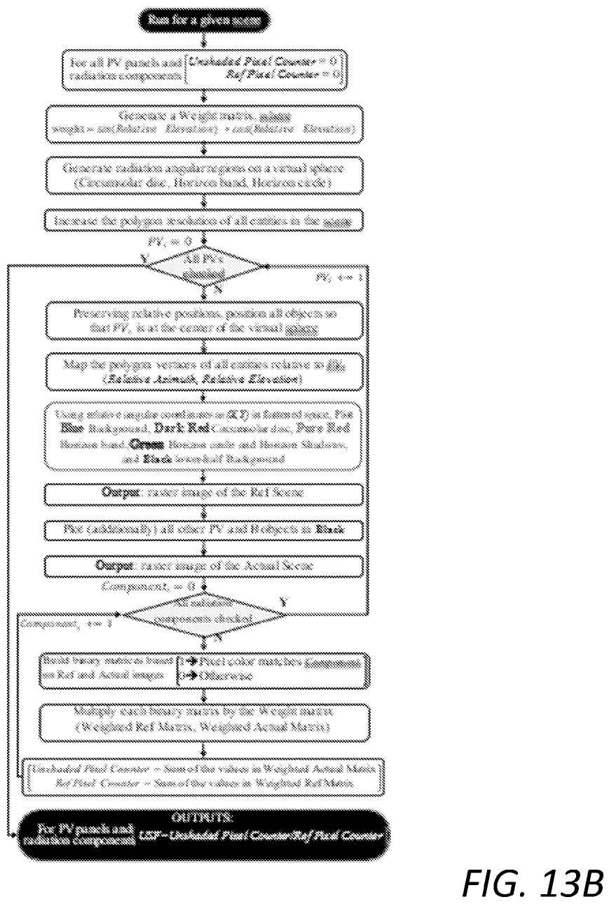

In the third approach, Pix-Flat considers all POV directions at the same time. The diffuse components are represented as sections of the sky sphere that are bounded by sets of angular coordinates (azimuth, elevation). These angular coordinates are mapped onto a flattened projection by interpreting them as 2D coordinates and keeping track of the spatial deformation during the flattening process. The mapped (flattened) diffuse components are then plotted and rasterized as polygons. Next, pixel-counting is used to calculate how much of any diffuse component is accessible to an arbitrary PV compared to a reference PV. Also, incidence and flattening effects are incorporated into a weight matrix. The flattening process is illustrated in FIG. 13A.

The comparison between target values and estimates from these approaches is used to characterize the angular sampling convergence behavior. This provides tentative initial starting settings and resolution ranges to examine convergence in the diffuse shadow modeling versions of the same approaches. Furthermore, the view factor intermediary versions are used to find the optimal angular heights for representing the horizon brightening component in the Pix-Flat approach.

### Diffuse Shadow Modelling

Three approaches are developed for estimating the unshaded factors for every diffuse component. As illustrated in FIG. 4, these approaches integrate the space sampling capabilities from beam shadow modeling and the angular sampling capabilities from view factor modeling. They are direct theoretical and practical extensions of the view factor versions. However, instead of empty scenes, virtual spaces are populated with potentially shadow-casting objects. Also, the reference scenarios here refer to ignoring shadows while maintaining the same PV positions and orientations.

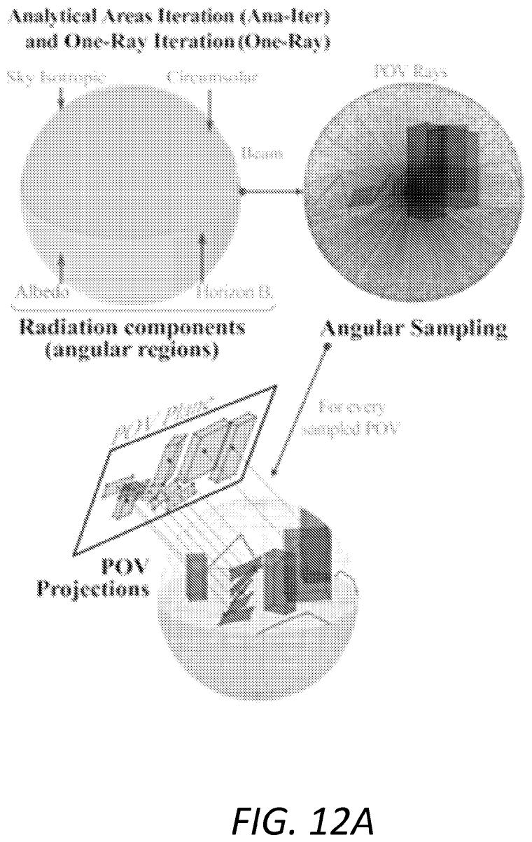

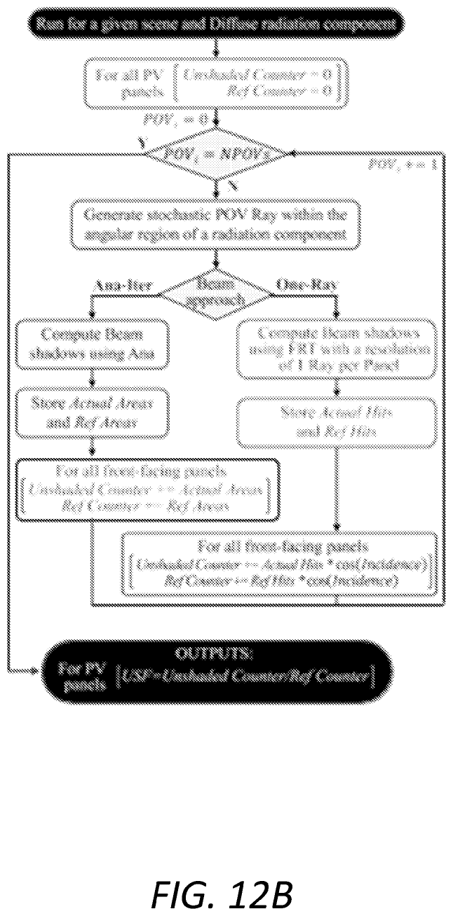

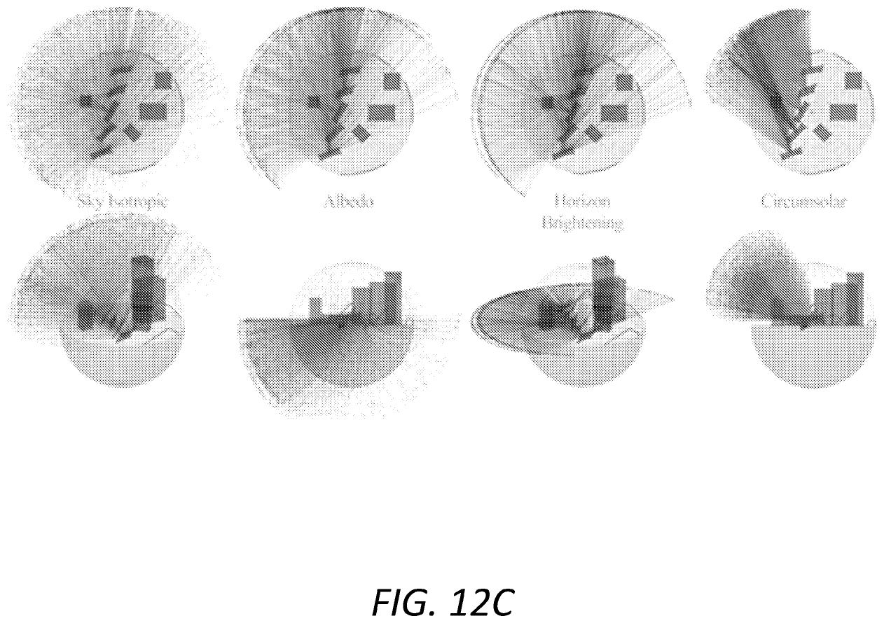

FIGS. 12(A-C) describe the Ana-Iter & One-Ray approaches for modeling diffuse shadows by sampling POV directions, projecting the scene onto every POV plane, computing beam shadows from every POV, and then integrating the results. FIG. 12A illustrates the angular regions of the anisotropic irradiance components. These are sampled by generating a number of POV directions with uniform distributions and delimited by the anisotropic angular regions. The relevant geometry of the scene is projected on the planes of every POV so that beam-like shadows can be computed for every sampled direction. Diffuse shadows result from aggregating these computed shadows throughout the anisotropic angular regions. FIG. 12B is a flowchart of the main steps of this method for estimating diffuse shadows.

In the case of Analytical Areas Iteration (Ana-Iter, FIG. 12B), the iterative beam-like shadows are calculated with the Ana-Iter approach. Ana-Iter employs analytical procedures to characterize the unobstructed harvesting areas (actual areas), as well as the harvesting areas of the same PVs but in a reference scenario where shadow intersections are ignored (ref. areas). In the case of One-Ray Iteration, beam shadows are computed with a method akin to Focused Ray Tracing (FRT), which generates one ray for every POV and for every PV at its center. The intersections between these rays and the polygons of the projected scene are analyzed and the algorithm checks whether they are blocked by the surroundings. The aggregated behavior results from the number of rays that reach the front-facing PVs, weighted by the cosine of the incidence. FIG. 12C shows examples of One-Ray simulations. Here, the proportion of black rays represents the amount of diffuse irradiance that is blocked by diffuse shadows. These are examples of ray iterations used to characterize the diffuse irradiance components. To improve the algorithm's efficiency, the rays that would reach the back of the harvesting surfaces are not generated, so their paths do not have to be computed. The rays that do reach the harvesting surfaces are displayed in red and the ones blocked by diffuse shadows in black.

The larger the number of POV directions (i.e., the angular resolution), the more detailed and sensitive the characterization of diffuse shadows becomes. In Ana-Iter, shadows are fully characterized for every POV, which is analogous to having a high spatial sampling resolution. Therefore, Ana-Iter is established as the “baseline” approach because it can have both high spatial and angular resolutions. Nonetheless, this can become too computationally intensive for some applications. By contrast, the One-Ray approach brings spatial resolution to a minimum by sampling every POV with only one ray per PV, which is examined as a way to navigate the trade-off between spatial and angular resolution, accuracy, and computational cost.

The third approach, Pixel-Counting in Flattened-Space (Pix-Flat), is also developed to navigate the spatial-angular trade-off. Instead of iterating beam shadow calculations from a distribution of POV directions (as with Ana-Iter and One-Ray), all directions are processed at the same time by “flattening” the 3D spherical space and mapping it onto 2D raster images. FIGS. 13(A-B) illustrate the Pix-Flat approach for modeling diffuse shadows. FIG. 13A shows that diffuse shadows are accounted for by flattening the angular space relative to a harvesting surface, mapping it onto raster images (Ref. without shadows and Actual Scenes with shadows), and then using rasterization and pixel-counting to estimate how much of the diffuse irradiances is accessible. FIG. 13B is a flowchart of the main steps of this method.

In this process, the scene is characterized in spherical coordinates (azimuth, elevation) relative to a harvesting surface. These coordinates are then treated as (X,Y) coordinates in a flat grid so that rasterization and pixel-counting can be used to estimate how much of the mapped radiation components are accessible. As an illustration of 3D-to-2D mapping, FIG. 13A shows a spherical surface divided into spherical “lunes”, which are flattened and aligned along their equator. White spaces are left between the lunes, so they are widened toward the tips to obtain a rectangular continuous space (in practice, the width of these lunes are infinitesimal). The horizontal axis of the resulting rectangular grid corresponds to the whole azimuthal range (from 180° to +180°) relative to the sphere's center, and the vertical axis is the whole elevation range (from 90° to +90°), measured from the relative equatorial plane.

This mapping procedure in Pix-Flat is implemented relative to every PV by generating virtual spheres at their centers with projections of the angular geometries that delimit the radiation components. In 3D space (before mapping), the sky Isotropic component is represented by the upper hemisphere, albedo by the lower hemisphere and the horizon shadows, circumsolar is represented by a disc centered along the beam direction, and horizon brightening by a spherical segment that spans from the equatorial plane up to a specified angular height (HB-height). One of the main practical advantages of Pix-Flat is that all anisotropic diffuse components are processed at the same time by encoding their angular regions with different colors. After the 3D geometries are flattened and rasterized, the number of pixels of any given irradiance component is used toward estimating how much of that irradiance is available to a harvesting surface. The Unshaded Factors result from counting pixels in an image of the Actual Scene with all the objects mapped, compared to a Reference Scene without other objects or Horizon Shadows (i.e., a shadowless scene).

When the geometries are mapped to the flattened space, they are stretched toward the boundaries of relative elevation (i.e., the vertical axis in flattened 2D space). To undo this dilation effect, pixel-counting is weighted by the cosine of relative elevation.

As shown in the flowchart of FIG. 13B, a weight matrix is generated to account for this dilation effect, as well as the Cosine Effect (also referred to as the Incidence Effect), which is modeled in this approach as the sine of the relative elevation. Also, the line segments of the objects in the scene can become curved due to the dilation effect. To better capture this curvature, the polygon faces of the objects are replaced by higher-resolution versions where every segment is broken down into N points. As previously described, a fixed number of points per segment can be used, but this may hinder the efficiency and accuracy of the approach. This is because N may not be enough for mapping intricate geometries, while at the same time being excessive for simpler details. This is overcome by implementing an adaptive segment splitting strategy, where the number of points per line depends on the relative angular span of every line segment. With this approach, every mapped line segment between two contiguous splitting points results in an angular span smaller or equal to an angle delta parameter that must be specified. A 2-degree angle delta is established because it is shown to be a good trade-off between curvature-mapping stability and computational cost. The accuracy of this approach appears to be more stable for the various levels of complexity in the surrounding infrastructure that were tested.

The 3D-to2D mapping procedure can become challenging while maintaining continuity along the vertical and horizontal boundaries. For instance, as shown in FIG. 14, if an entity is directly behind the PV, it must be divided into two sections at the left-right boundaries. Also, as an object appears closer to 90° in relative elevation, the dilation becomes more extreme, and continuity must be enforced in the upper-lower boundaries.

FIG. 14 illustrates sequential examples of how the 3D geometry of a scene is mapped onto a 2D flattened space. FIG. 14 (top view): an inclined PV (β 25°) rotates toward the left (−γ). An upper narrow row shows the visible portion of sky isotropic irradiance accounting for the weights of the dilation and incidence effects. FIG. 14 (middle view): A PV rotates toward the ground (+β), going from horizontal to vertical orientation. FIG. 14 (bottom view): A horizontal PV is fixed (β 0°) while the circumsolar disc rises from behind, with the beam Incidence decreasing (−θ_{B}) until it becomes perpendicular. The upper narrow row shows the weighted visible section of circumsolar radiation.

Pix-Flat and One-Ray minimize spatial sampling in a way that is conceptually similar. In Pix-Flat, when the geometries are mapped relative to the center of a harvesting surface, every radiation pixel is focused only toward the center of that surface. This is similar to how One-Ray uses only one ray aiming at the center of every PV from every sampled direction. The hypothesis in this regard is that One-Ray and Pix-Flat should converge to a similar modeling accuracy and should be capable of partially compensating for their low spatial resolution by requiring higher angular resolution. Furthermore, as Ana-Iter can have high spatial resolution as well as high angular resolution, the hypothesis is that it should be capable of achieving full convergence but at a higher computational cost. Sampling resolution improves in Ana-Iter and One-Ray by increasing the number of POV Directions sampled (thus increasing angular resolution), and in Pix-Flat by increasing the number of pixels in the mapped raster images (this also leads to increased angular resolution in Pix-Flat). Both situations are similar because the center of every pixel corresponds to a particular POV direction. In Pix-Flat, the number of pixels results from 360°/Angular Delta° for flattened width, and 180°/Angular Delta° for height, which is related to a full 360° range in relative azimuth and 180° range in relative elevation.

FIGS. 12(A-C) and FIGS. 13(A-B) describe the main structure of the diffuse shadow modeling approaches. Additional considerations are required for the appropriate behavior of the algorithms, such as accounting for division by zero and rounding errors, accounting for PV surfaces that are not facing the POV plane or ensuring that the output images in Pix-Flat have the appropriate size and aspect ratio and adhere to the target resolution. Diffuse USF are constrained below 1 for all components except albedo, as this is the only component where USF>1 can occur. For instance, if a PV is almost horizontal, there is almost no access to the lower Albedo hemisphere in the reference scenario, while in the Actual Scene, the PV may access irradiance from the ground extensions (i.e., the Horizon Shadows). Thus, the actual albedo irradiance can be greater than in the Reference shadow-less scenario (i.e., implying USFA>1).

### Shading Effect Assumptions Toward Power Estimations

One of the main uses of USF is for calculating how much of the anisotropic Irradiances (I in W/m²) is effectively available for harvesting. For a given location, it is often possible to obtain the measured distributions of global and beam irradiance that would be available to an unshaded horizontal surface. This data may be obtained from the National Solar Radiation Database (NSRDB) for locations of interest. Based on this data, all-weather transposition models like HDKR or the Perez models can be used to decompose horizontal global irradiance into the anisotropic components and estimate the intensity with which the components reach unshaded surfaces with any orientation. These components are I_{B}, I_{DC}, I_{DI}, I_{A}, I_{DH}, representing Beam, Diffuse Circumsolar, Diffuse sky Isotropic, Albedo, and Diffuse Horizon Brightening.

By using the transposed Irradiances along with the corresponding USF, the Total Unshaded Irradiance (I_{S}) can be calculated, which represents the maximum power that can be harvested by a generic surface. If the harvesting device has a protective semitransparent covering layer, additional power losses are expected due to absorptance and reflectance, so only a portion of the Irradiance is transmitted. Thus, Transmittance factors (τ) are calculated here for every Irradiance component. The Total Geometrically Unshaded and Transmitted Irradiance (I_{τsg}) can then be obtained by including shadow and T losses, and this represents the maximum available power after going through the covering layer of some sort of solar device.

I_{τsg} is described as “Geometrically Unshaded” because shadow factors here only limit the Irradiance components to the extent that shadows reduce the visible harvesting area. In addition to this geometrical effect, there is an experimentally-adjusted factor that accounts for electrical losses in Photovoltaic devices due to the number of shaded PV Blocks (NSB) compared to the total number of Blocks (NB) in a panel. This NSB factor is only related to the directional irradiance components (i.e., Beam and Circumsolar). It implies that, regardless of its area, a Beam shadow causes greater energy losses if the shaded area involves more Blocks. A PV Block is considered “shaded” in this work whenever its USFB drops below 97%, which is like shading 50% of the area of a solar cell in a 3-Block panel with 60 cells in total. The Total Effective Irradiance (I_{τs}) is then calculated by considering losses related to transposition, transmittance, geometrical shadows, and shadow-induced electrical mismatches.

Different shadow modeling assumptions lead to particular models of how shadows affect the available Irradiance toward power output estimations. Iₛ, I_{τsg}, and I_{τs} are defined in Eqs. (8-10) according to a set of State of the Art (SOA) assumptions, in which only Beam shadows are modeled and USF_{B} is applied to both Beam and Circumsolar components. This is referred to as SOA because focusing only on Beam shadows has been commonly used for many applications. SOA implicitly assumes that USF_{DC} ≃USF_{B} and USF_{DI} ≃USF_{A} ≃USF_{DH}≃1. Namely, this approach assumes that circumsolar shadows behave the same as beam shadows, and it assumes that there are no other diffuse shadows beyond circumsolar.

$${I}_{s ( 1 )} = ( {I}_{B} + {I}_{DC} ) {USF}_{B} + {I}_{DI} + {I}_{A} + {I}_{DH} \qquad ( 8 )$$

$${I}_{τ sg ( 1 )} = ( {I}_{B} \cdot {τ}_{B} + {I}_{DC} \cdot {τ}_{DC} ) {USF}_{B} + {I}_{DI} \cdot {τ}_{DI} + {I}_{A} \cdot {τ}_{A} + {I}_{DH} \cdot {τ}_{DH} \qquad ( 9 )$$

$${I}_{τ s ( 1 )} = ( {I}_{B} \cdot {τ}_{B} + {I}_{DC} \cdot {τ}_{DC} ) {USF}_{B} ( 1 - \frac{NSB}{1 + NB} ) + {I}_{DI} \cdot {τ}_{DI} + {I}_{A} \cdot {τ}_{A} + {I}_{DH} \cdot {τ}_{DH} \qquad ( 10 )$$

Another set of shadow assumptions is “Iso” (Eqs. 11-13), which takes into account shadows related to beam and the isotropic components (i.e., Sky Isotropic and Albedo), and assumes USF_{DC} ≃USF_{DH} ≃1. This approach only considers beam shadows and isotropic shadows (i.e., for the sky isotropic and albedo irradiance components) and it assumes that there are no anisotropic shadows (i.e., no circumsolar or horizon brightening shadows).

$${I}_{s ( 2 )} = {I}_{B} \cdot {USF}_{B} + {I}_{DC} + {I}_{DI} \cdot {USF}_{DI} + {I}_{A} \cdot {USF}_{A} + {I}_{DH} \qquad ( 11 )$$

$${I}_{τ sg ( 2 )} = {I}_{B} \cdot {τ}_{B} \cdot {USF}_{B} + {I}_{DC} \cdot {τ}_{DC} + {I}_{DI} \cdot {τ}_{DI} \cdot {USF}_{DI} + {I}_{A} \cdot {τ}_{A} \cdot {USF}_{A} + {I}_{DH} \cdot {τ}_{DH} \qquad ( 12 )$$

$${I}_{τ s ( 2 )} = ( {I}_{B} \cdot {τ}_{B} \cdot {USF}_{8} + {I}_{DC} \cdot {τ}_{DC} ) ( 1 - \frac{NSB}{1 + NB} ) + {I}_{DI} \cdot {τ}_{DI} \cdot US {F}_{DI} + {I}_{A} \cdot {τ}_{A} \cdot {USF}_{A} + {I}_{DH} \cdot {τ}_{DH} \qquad ( 13 )$$

The “Aniso” set of shadow assumptions (Eqs. 14-16) is an extension of SOA that considers all anisotropic components of the radiation, their corresponding USF and τ factors, and NSB implications. This is the approach of et preferred embodiment of the invention because it is the most comprehensive and theoretically consistent, since it recognizes that shadows can be cast for all beam and diffuse components.

$${I}_{s ( 3 )} = {I}_{B} \cdot {USF}_{B} + {I}_{DC} \cdot {USF}_{DC} + {I}_{DI} \cdot {USF}_{DI} + {I}_{A} \cdot {USF}_{A} + {I}_{DH} \cdot {USF}_{DH} \qquad ( 14 )$$

$${I}_{τ sg ( 3 )} = {I}_{B} \cdot {τ}_{B} \cdot {USF}_{B} + {I}_{DC} \cdot {τ}_{DC} \cdot {USF}_{DC} + {t}_{DI} \cdot {τ}_{DI} \cdot {USF}_{DI} + {I}_{A} \cdot {τ}_{A} \cdot {USF}_{A} + {I}_{DH} \cdot {τ}_{DH} \cdot {USF}_{DH} \qquad ( 15 )$$

$${I}_{τ s ( 3 )} = ( {I}_{B} \cdot {τ}_{B} \cdot {USF}_{B} + {I}_{DC} \cdot {τ}_{DC} \cdot {USF}_{DC} ) ( 1 - \frac{NSB}{1 + NB} ) + {t}_{DI} \cdot {τ}_{DI} \cdot {USF}_{DI} + {I}_{A} \cdot {τ}_{A} \cdot {USF}_{A} + {I}_{DH} \cdot {τ}_{DH} \cdot {USF}_{DH} \qquad ( 16 )$$

Lastly, “Aniso Geometric” (Eqs. 18-19) is the same as “Aniso”, but it does not consider NSB (i.e., Number Of Shaded PV Blocks) implications.

$${I}_{s ( 4 )} = {I}_{s ( 3 )} \qquad ( 17 )$$

$${I}_{τ sg ( 4 )} = {I}_{τ sg ( 3 )} \qquad ( 18 )$$

$${I}_{τ s ( 4 )} = {I}_{τ sg ( 3 )} \qquad ( 19 )$$

These equations describe the potentially available irradiances at different stages and based on different sets of shadow assumptions. Iₛ, I_{τsg}, and I_{τs} are respectively related to the Irradiance reaching the device, after passing through the covering layer, and after interacting with Block-diode connectors. The method disclosed herein focuses on the “Aniso” approach and uses the other sets of assumptions to analyze the energy implications of only modeling Beam shadows (SOA), Beam and isotropic shadows (Iso), or not taking into account Block-diode implications (Aniso Geometric). The available irradiances are among the main elements for estimating power output in the broader modeling framework.

Summarizing the second aspect of the invention, disclosed herein is a novel model for simulating diffuse shadows. For Diffuse shadow modeling, three approaches were discussed, the Ana-Iter approach, the One-Ray approach, and the Pix-Flat approach. The three approaches achieve consistent patterns of convergence within 5% deviations. The approach that iteratively calculates analytically-delimited areas (Ana-Iter) is the only one that achieves 1% convergence in all irradiance components. The approach based on rasterization in flattened space (Pix-Flat) appears to be the most efficient. At 5% convergence level, this approach is 7 to 30 times faster than the analytical approach and 4 to 20 times faster than the ray-based approach (One-Ray). Unlike the other two approaches, Pix-Flat has the practical advantage of processing all irradiance components at the same time. Also, its mean run-time as a function of angular resolution is remarkably constant up to a point of diminishing returns in accuracy and a spike in computational cost. Both Pix-Flat and One-Ray navigate an interesting trade-off, where efficiency is gained by reducing spatial resolution while partially compensating for it with an increase in angular resolution.

Regarding the integrated simulation tools, the Fast versions implement Pix-Flat for computing diffuse shadows, while the Detailed version uses Ana-Iter. The Pix-Flat approach is implemented at a 0.5-deg angular resolution, which is close to its 5% convergence level while avoiding its notable run-time spike at more demanding resolutions. As a result, the Fast tool with Full Heat Transfer is, on average, 552.7 times faster to run than the Detailed tool, taking only 3.7 seconds per simulated scene compared to 2011.1 seconds. The Fast Sandia version offers even greater efficiency gains because it uses an analytical approximation for the temperature at the PV surface (as opposed to using the numerical Full Heat Transfer approach), achieving a mean relative run-time of 573.47 times faster than the Detailed tool version.

As would be realized by one of skill in the art, many variations in the designs discussed herein fall within the intended scope of the invention. Moreover, it is to be understood that the features of the various embodiments described herein are not mutually exclusive and can exist in various combinations and permutations, even if such combinations or permutations were not made express herein, without departing from the spirit and scope of the invention. Accordingly, the method and system disclosed herein are not to be taken as limitations on the invention but as an illustration thereof. The scope of the invention is defined by the claims which follow.

1. A system for modeling and simulating solar harvesting comprising:
a virtual environment in which is a virtual scene is defined;
an irradiance model for modelling incident irradiances from a plurality of irradiance components;
a shadow model for modelling beam shadows and diffuse shadows for the plurality of irradiance components; and
a transmittance model for determining transmittance losses for the plurality of irradiance components.

2. The system of claim 1 wherein the virtual environment comprises:
a horizontal plane;
a horizon characterized as a ring at 0 degrees elevation; and
a spherical surface as an angular reference of the sky and ground domes.

3. The system of claim 2 wherein the virtual scene comprises:
a plurality of objects; and
a plurality of solar harvesting surfaces having a position and orientation that adjust as a function of time.

4. The system of claim 3 wherein each solar harvesting surface is defined by an azimuth angle, an inclination, and XYZ coordinates in virtual space.

5. The system of claim 3 wherein each object in the virtual scene is defined as a collection of one or more polygon faces characterized by a plurality of vertices.

6. The system of claim 3 wherein the virtual environment further comprises:
one or more horizon shadows.

7. The system of claim 6 wherein the horizon shadows comprise:
spherical surfaces delimited by sets of azimuth and elevation coordinates;
wherein the horizon shadows cast shadows at an angular level; and
wherein if an irradiance component from a given point-of-view falls within a horizon shadow, all radiation from that point-of-view is considered blocked.

8. The system of claim 3 wherein a solar position is defined by an azimuth angle and an elevation.

9. The system of claim 3 wherein inputs to the system include weather data and 3D geometrical data describing the objects and the solar harvesting surfaces in the virtual environment.

10. The system of claim 3 wherein the system outputs total power generated by the plurality of solar harvesting surfaces.

11. The system of claim 3 wherein the plurality of irradiance components comprises beam irradiance and a plurality of diffuse irradiance components comprising: sky isotropic irradiance, albedo irradiance, horizon brightening irradiance, and circumsolar irradiance.

12. The system of claim 3 wherein the shadow model uses a beam unshaded factor for modelling beam shadows and a diffuse unshaded factor for modeling diffuse shadows.

13. The system of claim 12 wherein the beam unshaded factor comprises:
a portion of a solar harvesting surface that is unobstructed, divided by a total area of the surface as seen from the point of view of beam irradiance.

14. The system of claim 12 wherein the diffuse unshaded factor comprises:
a proportion of a diffuse irradiance component that is accessible for harvesting from a given surface as a proportion of the diffuse irradiance component that would be accessible without shadows.

15. The system of claim 13 wherein determining the beam unshaded factor comprises:
projecting the virtual scene onto a plane that is aligned with a point-of-view of the Sun;
determining a projected harvesting area that is front-facing and unobstructed by shadows; and
determining a visible area in a shadow-less reference scenario;
wherein the unshaded factor for modelling beam shadows is a ratio of the harvesting area to the visible area.

16. The system of claim 14 wherein determining the diffuse unshaded factor comprises:
representing diffuse irradiance components as sections of a spherical surface that are bounded by sets of angular coordinates;
generating sets of angular distributions of points-of-view contained within angular regions of anisotropic irradiance components;
for every sampled point-of-view, computing shadow obstructions to rays coming in the direction of the points-of-view and aiming at front-facing harvesting surfaces;
for every sampled point-of-view, using projected geometries and the detected shadow obstructions to calculate the unshaded areas of the harvesting surfaces;
integrating the shadow effects throughout the delimited anisotropic angular regions to determine how much of each diffuse irradiance component is available to a harvesting surface in any orientation; and
integrating the available diffuse irradiance in a virtual reference scenario that is identical in terms of geometry but for which no shadows are accounted;
wherein the unshaded factor for modelling shadows for diffuse irradiance components is a ratio between the amount of each diffuse irradiance component available to the harvesting surface and the amounts calculated from the virtual reference scenario.

17. The system of claim 12 wherein the diffuse unshaded factor is applied to the sky isotropic, albedo, horizon brightening and circumsolar irradiance components.

18. The system of claim 13 wherein determining the beam unshaded factor comprises:
using an analytical areas approach in which visible areas of each photovoltaic cell are calculated analytically from points-of-view of beam rays.

19. The system of claim 13 wherein determining the beam unshaded factor comprises:
using a focused ray-tracing approach comprising:
generating a pre-defined number of rays at the surface of harvesting surfaces and in the direction of the solar angular position;
counting the rays that reach the front of the harvesting surface unobstructed; and
calculating the unshaded factor for beam irradiance as a ratio between a number of unobstructed rays and a total number of rays generated at every harvesting surface.

20. The system of claim 13 wherein determining the beam unshaded factor comprises:
using a rasterization and pixel-counting approach comprising:
placing a virtual camera aligned with an angular position of the sun;
sorting the objects in the scene based on their distance from the virtual camera;
plotting the polygons of the objects in the sorted order, wherein closest objects are plotted last;
generating a rasterized output image;
wherein every PV Block is plotted in a different color value and all other objects and background are plotted in black color;
for every PV Block, counting the number of pixels of the same color as the block in the output image to represent how much of its area is unobstructed by shadows; and
for every PV Block, calculating the beam unshaded factor as the ratio between the number of its visible pixels and the number of pixels counted in a second rasterized image output in which no shadows are cast (i.e., a reference shadowless scenario).

21. The system of claim 14 wherein determining the diffuse unshaded factor comprises:
using an analytical areas approach as the procedure for computing shadow obstructions to rays coming in the direction of every sampled point-of-view and that aim at front-facing harvesting surfaces.

22. The system of claim 14 wherein determining the diffuse unshaded factor comprises:
using a focused ray-tracing approach as the procedure for computing shadow obstructions to rays coming in the direction of every sampled point-of-view and that aim at front-facing harvesting surfaces;
wherein one virtual ray is generated at the center of every harvesting surface and for every sampled point-of-view;
wherein the available harvesting area for every harvesting surface and point-of-view is represented by the number of unobstructed rays that reach the surface; and
wherein the impact of this calculation on the integrated aggregate is weighted by the cosine of its incidence angle (i.e., the angle between the virtual rays and a harvesting surface).

23. The system of claim 14 wherein determining the diffuse unshaded factor comprises:
using a rasterization and pixel-counting in flattened space approach comprising:
representing diffuse irradiance components as sections of the spherical surface that are bounded by sets of angular coordinates;
calculating angular coordinates relative to every harvesting surface of all points that define the objects in the virtual scene and the spherical regions representing the diffuse components;
mapping the angular coordinates onto a flattened projection by interpreting them as 2D coordinates on a plane and tracking the spatial deformation during the flattening process;
plotting the mapped diffuse components, each component in a different color;
plotting the convex-hulls of the mapped objects in the scene as black polygons;
rasterizing all the plotted polygons in an output image;
for every diffuse irradiance component, counting a number of pixels in the output image of the same color as the plotted component;
adjusting the pixel count to account for dilation and incidence effects;
wherein the unshaded factor of any irradiance component results from the corresponding adjusted pixel-count divided by a pixel count from a second reference output image that includes only the mapped regions corresponding to the diffuse components.

24. The system of claim 1 wherein the transmittance models are used to obtain transmittance factors for the diffuse irradiance components.

25. The system of claim 24 wherein the transmittance losses are dependent on an angle of beam incidence, an angle of inclination of the photovoltaic cell and characteristics of a covering including thickness, extinction coefficient and refraction index.

26. The system of claim 1 wherein the modelling is iterated over a predetermined period of time to account for changing positions of the Sun, dynamic adjustments of harvesting surfaces, and dynamic changes to surrounding infrastructure.
